(19) United States
(12) Patent Application Publication
(10) Pub. No.: US 2008/0235139 A1
(43) Pub. Date: Sep. 25, 2008

(54) APPARATUS AND METHODS FOR DISTRIBUTING DIGITAL CONTENT

(76) Inventor: Georg MAGSCHOK, Macsch (DE)

Correspondence Address: GLENN PATENT GROUP, 3475 EDISON WAY, SUITE L, MENLO PARK, CA, 94025, US

(21) Appl. No.: 11/690,060

(22) Filed: Mar. 22, 2007

(51) Int. Cl. H04K 1/00

(52) U.S. Cl. 705/57

(57) ABSTRACT

An apparatus for distributing digital content, the digital content having associated therewith access information controlling access to the digital content depending on an action to be taken by a user, comprises an access controller for processing the access information; a digital content processor for using the digital content, the digital content processor being controllable by the access controller, wherein the access controller is operative to detect, whether the action has been taken by the user and to activate the digital content processor to process at least part of the digital content, when the user has taken the action, and wherein the action comprises one or more members of the group comprising copying the digital content at least one or more times, accessing a presentation material attached to a digital content, filling a questionnaire attached to the digital content, e-mailing the digital content to at least one or more e-mail addresses, putting the digital content on at least on or more websites or rendering an advertisement attached to the digital content.

### FIELD OF THE INVENTION

The present invention relates to the distribution of digital content and, particularly, to a way of maximizing distribution of digit content.

### BACKGROUND OF THE INVENTION AND PRIOR ART

Conventionally, the goal of digital rights management (DRM) is to limit an access to a digital content to one or only a small number of intended users. The digital content is so that an access to the digital content is restricted. Only when a user has bought a license, the user can access the digital content by e.g. decrypting the digital content. The key for decrypting the digital content was transmitted to the user after the user had paid for the license, for example.

All these methods intend to find a way of limiting access to digital content and to limit the distribution of the digital content compared to a situation in which any audio track or video file can be copied freely. In the case of digital rights management, copying of an encrypted file will not have any worth for the purchaser of the copy, when the purchaser of the copy does not have a decryption key. Thus, all conventional methods aim at minimizing distribution of digital content in order to make sure that only those parties gain access to the digital content who have paid for a license or who have signed a contract which intends to impose non-comfortable duties on the purchaser of the license, such as not copying the digital content or not distributing the digital content in any other way.

Such schemes can be enhanced to form a smarter copy control. Such copy controls include a maximum number of copies. To this end, digital content includes copy control information (CCI) which is typically in the form of some bits. For each copy, the copy value is increased. When a maximum number of copies is reached, then a copy device such as a specific software on a computer will deny further copies.

Regarding limiting distribution of digital content, reference is made to EP 1073273 A1 relating to a data processing device and data processing method.

To summarize, all these concepts have in common that the distribution of the digital content is limited and that access to the digital content is governed by different license strategies.

### SUMMARY OF THE INVENTION

An aspect of the present invention relates to an apparatus for distributing digital content, the digital content having associated therewith access information controlling access to the digital content depending on an action to be taken by a user, comprising: an access controller for processing the access information; a digital content processor for using the digital content, the digital content processor being controllable by the access controller, wherein the access controller is operative to detect, whether the action has been taken by the user and to activate the digital content processor to process at least part of the digital content, when the user has taken the action, wherein the action comprises one or more members of the group comprising copying the digital content at least one or more times, accessing a presentation material attached to a digital content, filling a questionnaire attached to the digital content, e-mailing the digital content to at least one or more e-mail addresses, putting the digital content on at least on or more websites or rendering an advertisement attached to the digital content.

A further aspect of the present invention relates to a method of distributing digital content, the digital content having associated therewith access information controlling access to the digital content depending on an action to be taken by a user, comprising: processing the access information; using the digital content in response to processing the access information, wherein, when processing the access information, it is detected, whether the action has been taken by the user and a usage of at least part of the digital content is allowed, when the user has taken the action, wherein the action comprises one or more members of the group comprising copying the digital content at least one or more times, accessing a presentation material attached to a digital content, filling a questionnaire attached to the digital content, e-mailing the digital content to at least one or more e-mail addresses, putting the digital content on at least on or more websites or rendering an advertisement attached to the digital content.

A further aspect of the present invention relates to a computer program having a machine-readable code which, when processed on a computer, results in the method of distributing digital content.

### BRIEF DESCRIPTION OF THE DRAWINGS

Different embodiments of the present invention are subsequently explained by reference to the accompanying drawings, in which:

FIG. 1 illustrates digital content having associated therewith access information and additional material;

FIG. 2 illustrates a block diagram of an exemplary apparatus and method for distributing digital content; and

FIG. 3 is a flow chart illustrating an embodiment of the method for distributing digital content.

### DETAILED DESCRIPTION OF PREFERRED EMBODIMENTS

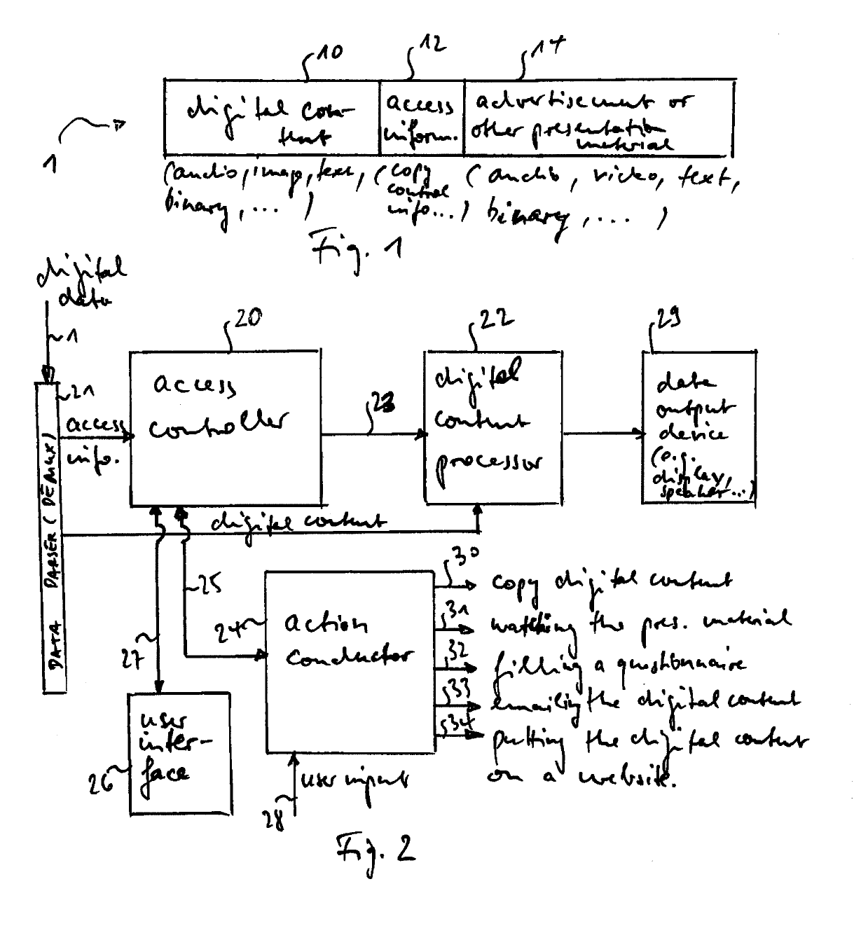

FIG. 1 illustrates a digital content 10, which comprises audio content, image content, text content, binary content or any other digital content useful for an application. The digital content has associated therewith access information, controlling access to the digital content depending on an action to be taken by the user. This access information can include copy control information. In one embodiment, the access information is included in the same bits reserved for copy control information by a certain data stream standard or data stream format. However, inventive access information is implemented by a specific bit combination which is not used by prior art standards.

Additionally, the digital content has associated therewith, in a specific example, an advertisement 14 or other presentation material. This advertisement material or other presentation material can comprise audio content, video content, text content, binary content or any other content useful for rendering towards the user. Particularly, when it is assumed that data item 14 includes an advertisement, then the provider of the advertisement 14 has a specific interest that the user watches, feels or hears the advertisement. Such an interest is, for example, a commercial interest, since the advertisement should enhance the user's intention to buy some goods or services.

Other presentation material can include questionnaires, serving some statistical or life-style purpose. In this situation, the provider of the questionnaire has an interest to gain knowledge about a certain behavior of the customers without enhancing the user's intention to buy something. However, the information given by the user in response to the presentation material 14 has some worth for the provider of the presentation material.

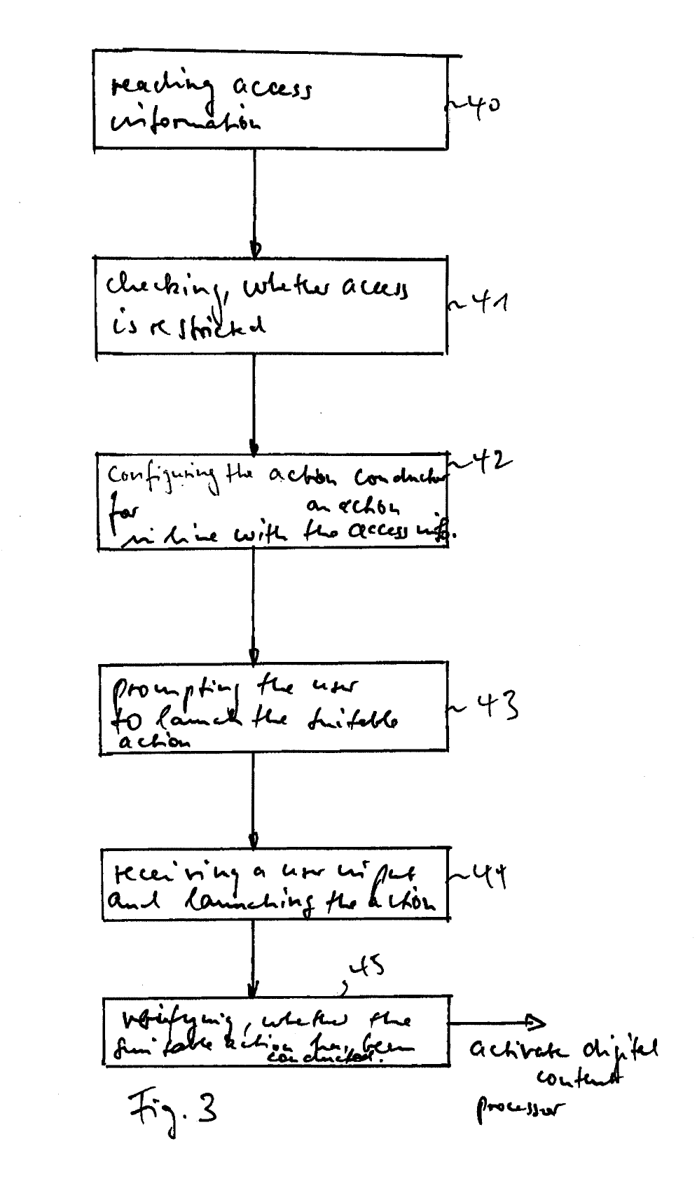

FIG. 1 illustrates a specific example for the inventive apparatus for distributing digital content. The apparatus shown in FIG. 2 includes an access controller 20 for processing the access information 12 provided from a data parser 21. The data parser 21 receives, as an input, the digital data 1, including the digital content 10, the access information 12 and probably the advertisement or other presentation material 14. The data parser 21 is adapted to extract the access information and to provide the access information to the access controller. Furthermore, the data parser 21 is adapted to provide the digital content to a digital content processor 22 for using the digital content. The digital content processor 22 is controllable by the access controller via the control line 23. Particularly, the access controller is operative to detect, whether the action has been taken by the user and to activate the digital content processor to process at least a part of the digital content, when the user has taken the action. To this end, the access controller 20 can control an action conductor 24 via a control line 25. Furthermore, the access controller 20 can communicate with a user interface 26 via an interface communication line 27. When the type of action to be taken by the user is also identified in the access information 12, then the access controller 20 controls the user interface 26 via the control line 27 to output an audio, video or other sensory message to the user, so that the user knows which action is to be taken by the user. Then the user activates the action conductor 24 via user input 28. Alternatively, the user may induce a certain action via input into the access controller 20 and then the access controller activates the action conductor 24 via control line 25.

In accordance with the present invention, the action to be taken by the user to gain access to the digital content comprises one or a combination of several actions from the group having the action of copying digital content 30, watching 31 the presentation material 14, filing a questionnaire 32, e-mailing the digital content 33 or putting the digital content on a website 34. All these actions do not involve any license handling, since all these actions can be taken by the user without any payment from the user.

Importantly, the user can conduct any such action without paying any money to anyone. Furthermore, all those actions do not result in a situation, in which the user ends up with restricted rights, which would be the case when one has to sign a license agreement. Instead, all these actions neither incur costs for the user nor involve limitation of rights of the user. However, the user's property is enhanced by conducting such actions, since when the access controller has verified that a certain action has been conducted by the user, then the access controller 20 will control the digital content processor 23 to process the digital content.

This results in the comfortable situation for the user that the user can enjoy the digital content output by a data output device, which can be, for example, a display device, a speaker device or any other device for outputting data for a user. This data output device 29 is provided with data from the digital content processor 22. Preferably, the digital content processor 22 performs a decryption of the digital content. However, in contrast to decryption policies, which restrict access to digital content and which only grant access to the digital content when the user has paid some money, etc., the digital content processor 22 of FIG. 2 starts decryption in response to the fact that the user has copied the digital content or has performed any other action, which enhances the user's property or the user's situation of rights rather than restricting the user's property or restricting the user's rights.

In one embodiment, a single copying action, for example, will always only result in granting access to a first portion of the digital content, such as a first song of a collection of songs of a certain author. When the user, then, performs an additional copy action of the digital content, then the user gains access to the second song, etc. Thus the user is remunerated for his distribution action by being in the position to enjoy the digital content without having to pay for the digital content or without having to sign any restrictions.

Digital rights management technology is, therefore, used as a super distribution mechanism. An example is that a DRM protected medium is only allowed to be replayed when one has copied this medium a certain number of times.

Furthermore, an additional embodiment includes the mechanism that the protected medium is replayed in a step by step fashion. Stated differently, each action provides the user with a bigger share of the digital content.

Alternatively, or additionally, the DRM protected medium is enabled by other actions such as viewing of advertisements, filling of questionnaires, etc. Thus, the user is remunerated for distributing digital content. This digital content may include marketing content, advertisement content, product samples, etc.

Preferably, copy control information (CCI) is used for specifying minimum distribution requirement to achieve the inverse goal of conventional DRM goals. The present embodiments care for the maximization of distribution, for example, for advertisements, hand-outs, give-aways in any form of digital media or demos as examples for digital content to be distributed.

Typical media transports define some two or three bits of copy control information with the values no additional copy, only a single copy is allowed, or several copies are allowed. However, in such copy control situations, allowing of a certain number of copies or not does not have any influence, whether the digital content can be accessed or not. In accordance with preferred embodiments of the pre-sent invention, often existing free or reserved bits of the copy control information or free or reserved bit combinations of copy control information bits are used to be interpreted by an access controller as “copy/distribute a given amount of times before using” or “view included program a given amount of times before using”, wherein program means, for example, multiplexed media programs.

There exists several standards which use copy control information. One such standard is AACS for Blu Ray. Here, the access information 12 from FIG. 1 can be introduced as a CCI expansion through CCI_and_author_info_type. In this case, it is even possible to specify amount, time frame and other requirements for the distribution without introducing additionally non-standardized bits.

An alternative application field is the usage of copy control information in AACS for HD-DVD. In this format there exist reserved combinations of PCCI which are used, in accordance with the present invention, to implement a novel access information 12, such as copy before using, watch a presentation material before using the digital content, filling a questionnaire before using the digital content, e-mailing the digital content before using the digital content or putting the digital content on the website before using the digital content.

In the VCPS format, the reserved bytes in the copy control information digest can be used for the same purpose.

In the DTCP-IP standard, the E-EMI of four bits leaves enough reserved combinations to define the above novel copy control information defining conditions which have to be fulfilled and which are directed to publishing, for example, before the digital content can be accessed.

In another field, i.e. in cable/satellite terrestrial conditional access systems, the copy control information bits defined by ANSI SCTE 41 2004 are used for the present invention.

As stated above, certain license requirements or usage rights configurable requirements have to be performed by the user so that the user gains access to digital content, which are exemplarily the following actions:

The digital content has to be e-mailed to a certain amount of email addresses (addressees) before being fully usable.

Advertisements or similar presentation material that are included or attached to the digital media and are bound to the digital media by means of crypto-technologies must have been presented for a certain amount of times or a certain time frame or each included advertisement or presentation material has to be visited as a prerequisite so that the user can access the digital content without any restrictions.

Alternatively, the digital content has to be written to an optical media before being fully usable.

Again, alternatively, the digital content has to be published on a web-page before being fully usable.

The control over the license requirements can be performed in accordance with specific needs. Examples are that a clearing house is involved that relays the e-mails. Alternatively, a burning software counts the number of burned processes to account for the DRM control or a http-request has to be issued to verify the publishing.

Encryption technologies can be optionally used. The output verification may be as strict as defined by any existing DRM technology.

FIG. 3 illustrates an optional embodiment of the method of distributing digital content. In step 40, access information attached to the digital content is read. In step 41, it is checked, whether the access to the digital content is restricted, or whether the user has already performed required actions earlier so that the access to the digital content is now free. In step 42, the access information are read to check out, which action has to be taken by the user, then the action conductor is configured for an action in line with the access information. This step is useful when several different actions are possible, in principle and a specific action is indicated by the access information. In step 43, a user is prompted to launch the suitable action indicated by the access information or indicated by the result of step 42. Naturally, steps 42 and 43 may also be exchanged so that the user is prompted to launch a specific action and, then, the action conductor is configured for this specific action. Particularly, such a configuration may take place after step 44, in which the apparatus for publishing or the method for publishing receives a user input in response to the prompting step 43. In response to a positive user input, the action is launched by the action conductor 24 of FIG. 2. In step 45 it is verified, whether the suitable action has been conducted by the user. When step 45 results in a positive verification, then the digital content processor 22 is activated to allow access to the digital content and to care for a rendering of the digital data via the digital output device 29.

Depending on certain implementation requirements of the inventive methods, the inventive methods can be implemented in hardware or in software. The implementation can be performed using a digital storage medium, in particular a disk, DVD or a CD having electronically readable control signals stored thereon, which cooperate with a programmable computer system such that the inventive methods are performed. Generally, the present invention is, therefore, a computer program product with a program code stored on a machine readable carrier, the program code being operative for performing the inventive methods when the computer program product runs on a computer. In other words, the inventive methods are, therefore, a computer program having a program code for performing at least one of the inventive methods when the computer program runs on a computer.

While the foregoing has been particularly shown and described with reference to particular embodiments thereof, it will be understood by those skilled in the art that various other changes in the form and details may be made without departing from the spirit and scope thereof. It is to be understood that various changes may be made in adapting to different embodiments without departing from the broader concepts disclosed herein and comprehended by the claims that follow.

What is claimed is:

1. Apparatus for distributing digital content, the digital content having associated therewith access information controlling access to the digital content depending on an action to be taken by a user, comprising:
an access controller for processing the access information;
a digital content processor for using the digital content, the digital content processor being controllable by the access controller,
wherein the access controller is operative to detect, whether the action has been taken by the user and to activate the digital content processor to process at least part of the digital content, when the user has taken the action,
wherein the action comprises one or more members of the group comprising copying the digital content at least one or more times, accessing a presentation material attached to a digital content, filling a questionnaire attached to the digital content, e-mailing the digital content to at least one or more e-mail addresses, putting the digital content on at least on or more websites or rendering an advertisement attached to the digital content.

2. Apparatus in accordance with claim 1, wherein the access controller is operative to receive action information from a local device regarding the action or to receive action information from a remote device regarding the action, and
wherein the access controller is operative to use the action information when verifying, whether the action has been taken by the user.

3. Apparatus in accordance with claim 1, in which the digital content includes audio or video information, and
wherein the digital content processor is an audio processor or a video processor for rendering the digital content.

4. Apparatus in accordance with claim 1, in which the access information comprises predefined values of a group of bits provided for copy control information, wherein the predefined values are different from values for the same group of bits allowing no copying or a restricted number of copies.

5. Apparatus in accordance with one of the preceding claims, in which the access controller is adapted:
to detect when a user wishes to access the digital content;
to control a user interface to prompt the user to perform the action;
to detect, whether the action has been taken by the user.

6. Apparatus in accordance with claim 1, in which the digital content is encrypted, and
in which the access controller is adapted to enable a decryption when the user has taken the action.

7. Apparatus in accordance with claim 6, in which the access controller is operative to retrieve a decryption key and decrypt the digital content based on the decryption key.

8. Apparatus in accordance with one of the preceding claims, in which the access information includes a CCI expansion through CCI_and_author_info_type in an AACS format for Blu Ray.

9. Apparatus in accordance with claim 1, in which the access information includes a reserved combination of a PCCI portion in an AACS format for HD-DVD.

10. Apparatus in accordance with claim 1, in which the access information includes reserved bytes in a CCI Digest in a VCPS format.

11. Apparatus in accordance with claim 1, in which the access information includes an E-EMI of four bits in a DTCP-IP format.

12. Apparatus in accordance with claim 1, in which the access information includes CCI bits defined by ANSI SCTE 41 2004 in a cable, satellite, or terrestrial conditional access system.

13. Apparatus in accordance with claim 1, in which the action comprises sending one or more e-mails and wherein the apparatus further comprises an action conductor adapted to send the e-mail via a clearing house, and
wherein the access controller is operative to receive information from a clearing house relating to sending the one or more e-mails by the action conductor.

14. Apparatus in accordance with claim 1, in which the action comprises copying the digital content on an optical medium one or more times, and in which a software running on an optical drive is operative to count the number of copy processes involving the digital content.

15. Apparatus in accordance with claim 1, in which the action comprises putting the digital content on the at least one website, and
wherein the access controller is adapted to monitor whether an http-request has been issued.

16. Apparatus in accordance with claim 1, in which the at least one website is a public website, on which the digital content is available for the public.

17. Apparatus in accordance with claim 1, in which the digital content includes a plurality of portions,
wherein the action is copying the digital content at least twice, and
wherein the access controller is operative to activate a first portion in response to a first copy action taken by the user and to activate a second portion in response to a second action taken by the user,
wherein the second portion was not accessible for the digital content processor after the first copy action and before the second copy action.

18. Apparatus in accordance with claim 1, in which the digital content has associated therewith an advertisement or a presentation material, which is different from the digital content, and which is suitable for a non-restricted access,
wherein the access controller is operative to activate the digital content processor in response to an access to the advertisement or to the presentation medium.

19. Apparatus in accordance with claim 18, in which the access controller is operative to detect, whether the access has taken place a predetermined number of times or in a certain time frame or a certain time period as indicated in the access information.

20. Apparatus in accordance with claim 18, in which the advertisement or the presentation medium is bound to the digital content using cryptographic methods.

21. Method of distributing digital content, the digital content having associated therewith access information controlling access to the digital content depending on an action to be taken by a user, comprising:
processing the access information;
using the digital content in response to processing the access information,
wherein, when processing the access information, it is detected, whether the action has been taken by the user and a usage of at least part of the digital content is allowed, when the user has taken the action,
wherein the action comprises one or more members of the group comprising copying the digital content at least one or more times, accessing a presentation material attached to a digital content, filling a questionnaire attached to the digital content, e-mailing the digital content to at least one or more e-mail addresses, putting the digital content on at least on or more websites or rendering an advertisement attached to the digital content.

22. Computer program for performing, when running on a computer, a method of distributing digital content, the digital content having associated therewith access information controlling access to the digital content depending on an action to be taken by a user, the method comprising:
processing the access information;
using the digital content in response to processing the access information,
wherein, when processing the access information, it is detected, whether the action has been taken by the user and a usage of at least part of the digital content is allowed, when the user has taken the action,
wherein the action comprises one or more members of the group comprising copying the digital content at least one or more times, accessing a presentation material attached to a digital content, filling a questionnaire attached to the digital content, e-mailing the digital content to at least one or more e-mail addresses, putting the digital content on at least on or more websites or rendering an advertisement attached to the digital content.
